(19) United States
(12) Patent Application Publication
(10) Pub. No.: US 2018/0195657 A1
(43) Pub. Date: Jul. 12, 2018

(54) ILLUMINATED HOSE

(71) Applicant: Campbell Hausfeld, LLC, Harrison, OH (US)

(72) Inventors: Nicholas Steven Hafele, Cincinnati, OH (US); Brandon Lee Cross, Centerville, OH (US)

(21) Appl. No.: 15/862,984

(22) Filed: Jan. 5, 2018

Related U.S. Application Data
(60) Provisional application No. 62/443,298, filed on Jan. 6, 2017.
(60) Provisional application No. 62/479,472, filed on Mar. 31, 2017.

(51) Int. Cl. F16L 55/07; F16L 11/12; F16L 37/10; F21S 4/10; F21V 23/02; F21V 23/06

(52) U.S. Cl. CPC F16L 55/07; F16L 11/12; F16L 37/10; F21Y 2115/10; F21V 23/02; F21V 23/06; F21S 4/10

(57) ABSTRACT

An illuminated hose includes an elongated illumination source that is routed through an inlet fitting and a conduit. The conduit is light permeable to allow light from the elongated illumination source to be visible to a surrounding environment.

### REFERENCE TO RELATED APPLICATIONS

This application claims priority of U.S. provisional patent application Ser. No. 62/443,298, entitled Illuminated Hose and Methods for Same, filed Jan. 6, 2017, and U.S. provisional patent application Ser. No. 62/479,472, entitled Illuminated Hose and Methods for Same, filed Mar. 31, 2017, and hereby incorporates these provisional patent applications by reference herein in their entirety.

### TECHNICAL FIELD

The apparatus and methods described below generally relate to an illuminated hose. More particularly the illuminated hose is a pneumatic hose for providing pressurized fluid to a pneumatic device.

### BACKGROUND

Hoses can be used for a variety of different applications. When ambient lighting is low, these hoses can be difficult to see.

### SUMMARY

In accordance with one embodiment, a fluid hose comprises a conduit, an inlet fitting, an elongated illumination source, and a sealing arrangement. The conduit defines a first passageway. The inlet fitting comprises a fluid input port, a fluid output port, and an electrical input port. The fluid input port is configured for releasable attachment to a pressurized fluid source. The inlet fitting defines a second passageway that extends between the fluid input port and the fluid output port. The fluid output port is fluidly coupled with the conduit such that the first passageway and the second passageway are in fluid communication with each other. The electrical input port is disposed adjacent to the fluid input port and defines a third passageway that converges with the second passageway. The elongated illumination source is routed at least partially through the third passageway, through the second passageway and into the first passageway. The elongated illumination source is configured for powering by a remote power source and is configured to distribute light longitudinally and radially along the conduit. The sealing arrangement is at least partially disposed within the electrical input port. The elongated illumination source extends from the sealing arrangement. The sealing arrangement is configured to substantially seal an interface between the electrical input port and the elongated illumination source.

In accordance with another embodiment, a fluid hose comprises a conduit, an inlet fitting, an elongated illumination source, and a sealing arrangement. The conduit defines a first passageway and comprises a distal end. The inlet fitting comprises a fluid input port, a fluid output port, and an electrical input port. The fluid input port is configured for releasable attachment to a pressurized fluid source. The inlet fitting defines a second passageway that extends between the fluid input port and the fluid output port. The fluid output port is fluidly coupled with the conduit such that the first passageway and the second passageway are in fluid communication with each other. The electrical input port is disposed adjacent to the fluid input port and defines a third passageway. The elongated illumination source is routed at least partially through the third passageway, through the second passageway and into the first passageway. The elongated illumination source is configured for powering by a remote power source and is configured to distribute light longitudinally and radially along the conduit. The sealing arrangement is at least partially disposed within the electrical input port. The elongated illumination source extends from the sealing arrangement. The sealing arrangement is configured to substantially seal an interface between the electrical input port and the elongated illumination source. The inlet fitting and the conduit cooperate to define a fluid path that extends from the fluid input port, through the fluid output port, and to the distal end of the conduit. The elongated illumination source intersects the fluid path at a location that is downstream from the fluid input port.

In accordance with yet another embodiment, a pneumatic hose comprises a conduit, an inlet fitting, an elongated illumination source, and a sealing arrangement. The conduit defines a first passageway. The inlet fitting comprises a fluid input port, a fluid output port, and an electrical input port. The fluid input port is configured for releasable attachment to a pressurized fluid source. The inlet fitting defines a second passageway that extends between the fluid input port and the fluid output port. The fluid output port is fluidly coupled with the conduit such that the first passageway and the second passageway are in fluid communication with each other. The electrical input port is disposed adjacent to the fluid input port and defines a third passageway that converges with the second passageway. The elongated illumination source is routed at least partially through the third passageway, through the second passageway and into the first passageway. The elongated illumination source is configured for powering by a remote power source and is configured to distribute light longitudinally and radially along the conduit. The sealing arrangement is at least partially disposed within the electrical input port. The elongated illumination source extends from the sealing arrangement. The sealing arrangement is configured to substantially seal an interface between the electrical input port and the elongated illumination source. The inlet fitting and the conduit cooperate to define a fluid path that extends from the fluid input port, through the fluid output port, and to a distal end of the conduit. The elongated illumination source intersects the fluid path at a location that is downstream from the fluid input port.

### BRIEF DESCRIPTION OF THE DRAWINGS

Various embodiments will become better understood with regard to the following description, appended claims and accompanying drawings wherein:

FIG. 1 is a sectional view depicting an illuminated pneumatic hose, in accordance to one embodiment; and

FIG. 2 is a side view depicting an illuminated pneumatic hose, in accordance with another embodiment.

### DETAILED DESCRIPTION

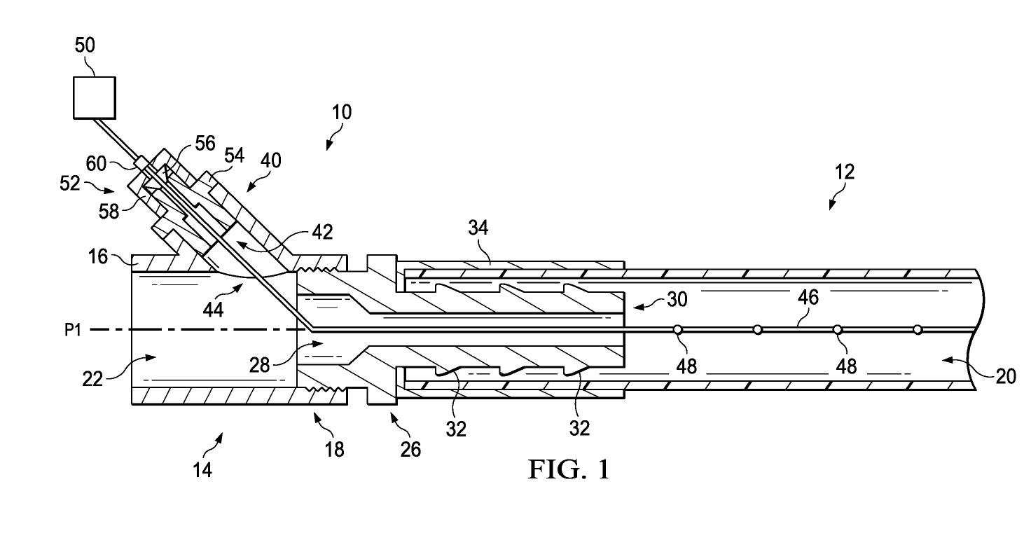

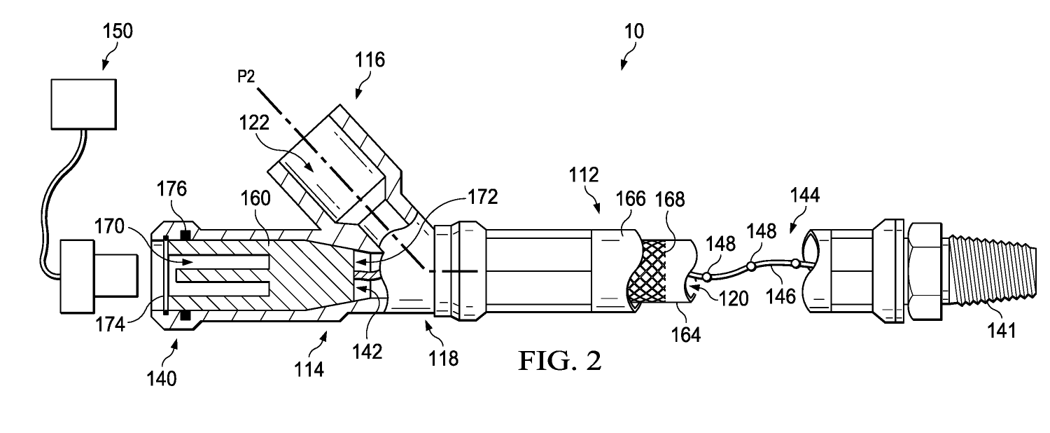

Embodiments are hereinafter described in detail in connection with the views and examples of FIGS. 1 and 2. A pneumatic hose 10 in accordance with one embodiment is generally depicted in FIG. 1. The pneumatic hose 10 can include a conduit 12 and an inlet fitting 14 that includes a fluid input port 16 and a fluid output port 18. The conduit 12 can define a passageway 20. The inlet fitting 14 can define a passageway 22 that extends between the fluid input port 16 and the fluid output port 18.

The fluid input port 16 can be configured to facilitate attachment of the pneumatic hose 10 to a pressurized fluid source (not shown), such as an air compressor. The fluid input port 16 can be coupled to the fluid source via threaded attachment, a quick connect coupling, a fixed coupling (e.g., welded coupling), or any of a variety of other suitable alternative connections.

The fluid output port 18 can be fluidly coupled with the conduit 12 such that the passageways 20, 22 are in fluid communication with one another. In one embodiment, as illustrated in FIG. 1, the pneumatic hose 10 can also include a barbed fitting 26 that is coupled with the fluid output port 18 of the inlet fitting 14 (e.g., through threaded engagement) and can define a passageway 28. The barbed fitting 26 can include a barbed end 30 that projects into the conduit 12. The barbed end 30 can include a plurality of barbs 32 that embed into the conduit 12 to facilitate securement of the barbed fitting 26 thereto. In one embodiment, a hose clamp 34 can surround the conduit 12 at the barbed end 30 to enhance the securement therebetween.

The respective passageways 22, 28 of the inlet fitting 14 and the barbed fitting 26 can be in communication with each other and can extend to the conduit 12. The passageway 20 of the conduit 12 can be in communication with the respective passageways 22, 28 of the inlet fitting 14 and the barbed fitting 26. As such, the inlet fitting 14, the barbed fitting 26, and the conduit 12 can cooperate to define a fluid path P1 that extends from the fluid input port 16, through the fluid output port 18, through the barbed fitting 26, and to a distal end (not shown) of the conduit 12 that is configured for releasable coupling to a pneumatic device. In one embodiment, the fluid input port 16 and the fluid output port 18 can be substantially aligned, such that the portion of the fluid path P1 defined by the inlet fitting 14 is substantially coaxial.

A fitting (not shown) can be provided at the distal end to facilitate releasable fluid coupling of a pneumatic device (not shown) to the conduit 12. Example pneumatic devices can include a pneumatic hand tool, such as an impact driver or orbital sander; a fluid dispenser, such as an air gun or a paint sprayer; or a fluid storage device, such as an air tank. When a fluid source (not shown), such as an air compressor, is coupled to the fluid input port 16 and provides pressurized fluid (e.g., pressurized air) to the fluid input port 16, the pressurized fluid can flow along the fluid path P1 through the distal end and to the pneumatic device to facilitate powering of the pneumatic device.

The inlet fitting 14 can include an electrical input port 40 that is disposed adjacent to the fluid input port 16 (e.g., angled relative to the fluid input port 16) and defines a passageway 42. The passageway 42 can extend through the electrical input port 40 and can converge with the passageway 22 of the fluid input port 16. The fluid input port 16 and the electrical input port 40 can be arranged relative to each other such that the respective passageways 22, 42 are separate from each other (e.g., are fluidly isolated from each other) at a location upstream from where the passageways 22, 42 converge. In one embodiment, as illustrated in FIG. 1, the electrical input port 40 and the fluid input port 16 can be angled with respect to each other such that the passageways 22, 42 are arranged generally in a Y-shape.

The pneumatic hose 10 can include an elongated illumination source 44 that is routed through the electrical input port 40 (e.g., along the passageway 42), through a portion of the passageway 22, through the passageway 28 of the barbed fitting 26, and into the passageway 20 of the conduit 12. As such, the elongated illumination source 44 can intersect the fluid path P1 at a location that is downstream from the fluid input port 16. The elongated illumination source 44 can be configured to distribute light in both a longitudinal and radial direction (e.g., light that is radial to a longitudinal centerline or axis defined by the passageway 20) along the conduit 12. In one embodiment, as illustrated, the elongated illumination source 44 can comprise a wire strand 46 that electrically interconnects a plurality of individual lights 48 (e.g., LEDs or incandescent lights) that are spaced apart from each other along a length of the wire strand 46. The elongated illumination source 44 can be powered by an external power source 50 which can be a wall plug, battery, a solar panel, or any other power source. In another embodiment, the elongated illumination source 44 can comprise a substantially continuous light rod (not shown) that distributes substantially uniform light in both radial and longitudinal directions along the length of the conduit 12. In such an embodiment, the elongated illumination source 44 can be actively illuminated, such as, for example, via electroluminescence or electrophosphorescense (e.g., that is powered from the external power source 50), or can be passively illuminated, such as, for example, via phosphorescence. In some embodiments, the elongated illumination source 44 can include a socket, plug or other electrical disconnect device (not shown) that facilitates selectively disconnection of the elongated illumination source 44 from the external power source 50. It is to be appreciated that the elongated illumination source 44 can comprise any of a variety of suitable additional or alternative light sources that distribute light along the conduit 12 and, in some embodiments, might be configured to only illuminate a portion or discrete portions of the conduit 12.

The conduit 12 can be formed of a light-permeable material (e.g., an opaque, translucent or transparent material) that is configured to allow light from the elongated illumination source 44 to be visible through the conduit 12 thereby illuminating the conduit 12. It is to be appreciated that the conduit 12 can be formed of braided clear polyurethane or any of a variety of suitable additional or alternative materials that are light-permeable and can withstand the pressure from the pressurized fluid. It is also to be appreciated that the elongated illumination source 44 can be any of a variety of suitable light sources that are capable of being routed internally through a conduit of a hose and selectively projecting light through the conduit to illuminate the conduit. Lighting the conduit 12 in this manner can make the pneumatic hose 10 easily noticeable in low light conditions which can help prevent a passerby from tripping over the pneumatic hose 10.

The elongated illumination source 44 can be routed through a sealing arrangement 52 that is disposed within the electrical input port 40. The sealing arrangement 52 can be configured to substantially seal the interface between the electrical input port 40 and the elongated illumination source 44 to prevent fluid from the fluid path P1 from escaping from the electrical input port 40. In one embodiment, as illustrated, the sealing arrangement 52 can include a compression fitting 54, a ferrule 56, and a nut 58. The compression fitting 54 can extend at least partially into the passageway 42 of the electrical input port 40. The ferrule 56 can be sandwiched between the compression fitting 54 and the nut 58 such that threading the nut 58 onto the electrical input port 40 can compress the ferrule 56 into the compression fitting 54 to create an effective fluid seal around the elongated illumination source 44. It is to be appreciated that any of a variety of suitable alternative sealing arrangements are contemplated for preventing fluid from the fluid path P1 from escaping from the electrical input port 40 with the elongated illumination source 44 inserted in the electrical input port 40. For example, in one embodiment, an over molded sealing arrangement can be provided over and between the electrical input port 40 and the elongated illumination source 44. In another embodiment, an epoxy based sealing arrangement can be interposed between the electrical input port 40 and the elongated illumination source 44.

When the fluid input port 16 of the inlet fitting 14 is attached to a fluid source, the fluid path P1 and a portion of the passageway 42 (up to the sealing arrangement 52) are pressurized. As such, the portion of the elongated illumination source 44 extending from the sealing arrangement 52 into the conduit 12 (e.g., the downstream portion of the elongated illumination source 44) can be subjected to the pressurized fluid from the fluid source. The downstream portion of the elongated illumination source 44 (e.g., the portion of the elongated illumination source 44 that extends between the sealing arrangement 52 and the distal end of the conduit 12) can be configured to be durable enough to withstand that pressurized environment. For example, the elongated illumination source 44 can be coated with an external layer that is strong enough to withstand the elevated pressure and impermeable enough to prevent any moisture in the pressurized fluid from adversely affecting the integrity of the wire strand 46 and individual lights 48.

The elongated illumination source 44 can include an electrical socket 60 that has an electrical input (not shown) that is fluidly isolated from the pressurized fluid from the fluid source (e.g., fluidly isolated from the passageway 22) and is accessible to the external power source 50. When the fluid input port 16 of the inlet fitting 14 is coupled to a fluid source, the electrical socket 60 can be independently plugged into an electrical source (not shown), such as a wall receptacle or a receptacle mounted on the fluid source (e.g., a compressor). As such, the electrical socket 60 can remain electrically isolated from the fluid source after being energized thereby alleviating exposure of the electrical connection to the pressurized fluid which could otherwise adversely affect the integrity of the electrical connection and increase the risk of electrical shock. In addition, when the pneumatic hose 10 is connected to the pressurized fluid source, and light from the elongated illumination source 44 is not needed (e.g., when there is sufficient ambient light), the elongated illumination source 44 can simply be unplugged from the power source without unplugging the rest of the pneumatic hose 10 from the pressurized fluid source, which can prolong the overall life of the elongated illumination source 44.

It is to be appreciated that, in one embodiment, the conduit 12 and the elongated illumination source 44 can be separate components. As such, the conduit 12 can support the elongated illumination source 44 internally without any physical connection therebetween (e.g., such as through embedding or molding the elongated illumination source 44 into the conduit 12). The elongated illumination source 44 can thus be inserted into the conduit 12 via known routing techniques, such as by blowing or fishing (e.g., with a guide wire) the elongated illumination source 44 though the passageway 20, which can be more cost effective and less time consuming than conventional techniques, such as, for example, embedding or molding a light source into a conduit. This can allow for different types of elongated illumination sources (e.g., different light colors, lighting intensities, light sources) to be easily installed into the conduit 12 thereby allowing for easier and inexpensive customized lighting options for the pneumatic hose 10.

FIG. 2 illustrates an alternative embodiment of a pneumatic hose 110 that is similar to or the same in many respects as pneumatic hose 10 shown in FIG. 1. For example, the pneumatic hose 110 can comprise a conduit 112 and an inlet fitting 114 that facilitates attachment of the pneumatic hose 110 to a pressurized fluid source (not shown).

The inlet fitting 114 can include a fluid input port 116 and a fluid output port 118. The conduit 112 can define a passageway 120. The inlet fitting 114 can define a passageway 122 that extends between the fluid input port 116 and the fluid output port 118. The fluid output port 118 can be fluidly coupled with the conduit 112 such that the passageways 120, 122 are in fluid communication with one another. The conduit 112 and the fluid output port 118, however, can be threadably coupled together. In particular, the conduit 112 can include a threaded end 162 that is threaded into the fluid output port 118.

The inlet fitting 114 and the conduit 112 can cooperate to define a fluid path P2 that extends from the fluid input port 116, through the fluid output port 118, and to a distal end 138 of the conduit 112. The distal end 138 can be configured for releasable coupling to a pneumatic device. A fitting 141 can be provided at the distal end 138 to facilitate releasable fluid coupling of a pneumatic device (not shown) to the conduit 112.

The inlet fitting 114 can include an electrical input port 140 that is disposed adjacent to the fluid input port 116 and defines a passageway 142 that converges with the passageway 122 of the fluid input port 116. The fluid input port 116 can be angled relative to the fluid output port 118 such that the portion of the fluid path P2 defined by the inlet fitting 114 is tortuous (e.g., is not coaxial).

The pneumatic hose 110 can include an elongated illumination source 144 that is routed through the electrical input port 140 (e.g., along the passageway 142), through a portion of the passageway 122, and into the passageway 120 of the conduit 112. The conduit 112 can include an inner tube 164 surrounded by an outer casing 166. Each of the inner tube 164 and the outer casing 166 can be formed of a light-permeable material to allow the light from the elongated illumination source 144 to be visible through the conduit 112. A reinforcing mesh 168 can be sandwiched between the inner tube 164 and the outer casing 166 and configured to enhance the structural integrity of the conduit 112. In one embodiment, the reinforcing mesh 168 can be formed of a translucent material, such as fiberglass or thermoplastic, for example, but in other embodiments, can be formed of an opaque material such as metal, for example.

The elongated illumination source 144 can include an electrical socket 160 that includes an electrical input 170 and an electrical output 172 that are in electrical communication with each other. The electrical output 172 can be electrically coupled with a wire strand 146 of the elongated illumination source 144 for powering individual lights 148. The electrical input 170 can be configured for mechanical and electrical connection with an external power source 150.

The electrical socket 160 can be disposed within the electrical input port 140 and retained within the electrical input port 140 by a circlip 174 or other arrangement, such as a threaded sleeve or through welding. An O-ring 176 (e.g., a sealing arrangement) can be provided between the electrical socket 160 and the electrical input port 140. The circlip 174 can provide enough downward force onto the electrical socket 160 to compress the O-ring 176 enough to create an effective fluid seal between the electrical input port 140 and the electrical socket 160. The electrical socket 160 can thus cooperate with the circlip 174 and the O-ring 176 to allow power flow between the electrical input 170 and the electrical output 172 while simultaneously preventing fluid from escaping from the electrical input port 140. It is to be appreciated that, in some embodiments, the sealing arrangement can be incorporated into the electrical socket 160. For example, in one embodiment, the electrical socket 160 can be formed of a resilient material, such as an elastomeric material. In such an embodiment, the electrical socket 160 itself can interact with the electrical input port 140 to create an effective seal therebetween.

The foregoing description of embodiments and examples has been presented for purposes of illustration and description. It is not intended to be exhaustive or limiting to the forms described. Numerous modifications are possible in light of the above teachings. For example, although a pneumatic hose is described herein, it is to be appreciated that other types of fluid hoses are contemplated such as, for example, a water hose. Some of those modifications have been discussed and others will be understood by those skilled in the art. The embodiments were chosen and described for illustration of various embodiments. The scope is, of course, not limited to the examples or embodiments set forth herein, but can be employed in any number of applications and equivalent devices by those of ordinary skill in the art. Rather, it is hereby intended that the scope be defined by the claims appended hereto. Also, for any methods claimed and/or described, regardless of whether the method is described in conjunction with a flow diagram, it should be understood that unless otherwise specified or required by context, any explicit or implicit ordering of steps performed in the execution of a method does not imply that those steps must be performed in the order presented and may be performed in a different order or in parallel.

What is claimed is:

1. A fluid hose comprising:
a conduit defining a first passageway;
an inlet fitting comprising:
a fluid input port configured for releasable attachment to a pressurized fluid source;
a fluid output port, the inlet fitting defining a second passageway that extends between the fluid input port and the fluid output port, the fluid output port being fluidly coupled with the conduit such that the first passageway and the second passageway are in fluid communication with each other; and
an electrical input port disposed adjacent to the fluid input port and defining a third passageway that converges with the second passageway;
an elongated illumination source routed at least partially through the third passageway, through the second passageway and into the first passageway, the elongated illumination source being configured for powering by a remote power source and configured to distribute light longitudinally and radially along the conduit; and
a sealing arrangement at least partially disposed within the electrical input port, wherein:
the elongated illumination source extends from the sealing arrangement; and
the sealing arrangement is configured to substantially seal an interface between the electrical input port and the elongated illumination source.

2. The fluid hose of claim 1, wherein the fluid input port and the electrical input port are angled with respect to each other such that the second passageway and the third passageway are arranged generally in a Y-shape.

3. The fluid hose of claim 1 wherein the elongated illumination source is configured to distribute light in each of a longitudinal direction and a radial direction.

4. The fluid hose of claim 3 wherein the elongated illumination source comprises a wire strand and a plurality of light emitting diodes that are spaced apart and electrically interconnected by the wire strand.

5. The fluid hose of claim 1 wherein the conduit is formed of a light-permeable material that is configured to allow light from the elongated illumination source to be visible through the conduit.

6. The fluid hose of claim 1 wherein the elongated illumination source further comprises an electrical socket that comprises an electrical input that is fluidly isolated from the second passageway and that is accessible to an external power source.

7. The fluid hose of claim 1 wherein the sealing arrangement comprises one or more of a ferrule and an O-ring.

8. The fluid hose of claim 1 wherein the conduit comprises a distal end that is configured for releasable coupling to a pneumatic device.

9. The fluid hose of claim 1 wherein the fluid hose comprises a pneumatic hose.

10. A fluid hose comprising:
a conduit defining a first passageway and comprising a distal end;
an inlet fitting comprising:
a fluid input port configured for releasable attachment to a pressurized fluid source;
a fluid output port, the inlet fitting defining a second passageway that extends between the fluid input port and the fluid output port, the fluid output port being fluidly coupled with the conduit such that the first passageway and the second passageway are in fluid communication with each other; and
an electrical input port disposed adjacent to the fluid input port and defining a third passageway;
an elongated illumination source routed at least partially through the third passageway, through the second passageway and into the first passageway, the elongated illumination source being configured for powering by a remote power source and configured to distribute light longitudinally and radially along the conduit; and
a sealing arrangement at least partially disposed within the electrical input port, wherein:
the elongated illumination source extends from the sealing arrangement;
the sealing arrangement is configured to substantially seal an interface between the electrical input port and the elongated illumination source;
the inlet fitting and the conduit cooperate to define a fluid path that extends from the fluid input port, through the fluid output port, and to the distal end of the conduit; and
the elongated illumination source intersects the fluid path at a location that is downstream from the fluid input port.

11. The fluid hose of claim 10, wherein the fluid input port and the electrical input port are angled with respect to each other such that the second passageway and the third passageway are arranged generally in a Y-shape.

12. The fluid hose of claim 10 wherein the elongated illumination source is configured to distribute light in each of a longitudinal direction and a radial direction.

13. The fluid hose of claim 12 wherein the elongated illumination source comprises a wire strand and a plurality of light emitting diodes that are spaced apart and electrically interconnected by the wire strand.

14. The fluid hose of claim 10 wherein the conduit is formed of a light-permeable material that is configured to allow light from the elongated illumination source to be visible through the conduit.

15. The fluid hose of claim 10 wherein the elongated illumination source further comprises an electrical socket that comprises an electrical input that is fluidly isolated from the second passageway and that is accessible to an external power source.

16. The fluid hose of claim 15 wherein the electrical socket is disposed at least partially within the electrical input port.

17. The fluid hose of claim 10 wherein the sealing arrangement comprises one or more of a ferrule and an O-ring.

18. The fluid hose of claim 10 wherein the distal end is configured for releasable coupling to a pneumatic device.

19. The fluid hose of claim 10 wherein the fluid hose comprises a pneumatic hose.

20. A pneumatic hose comprising:
a conduit defining a first passageway;
an inlet fitting comprising:
a fluid input port configured for releasable attachment to a pressurized fluid source;
a fluid output port, the inlet fitting defining a second passageway that extends between the fluid input port and the fluid output port, the fluid output port being fluidly coupled with the conduit such that the first passageway and the second passageway are in fluid communication with each other; and
an electrical input port disposed adjacent to the fluid input port and defining a third passageway that converges with the second passageway;
an elongated illumination source routed at least partially through the third passageway, through the second passageway and into the first passageway, the elongated illumination source being configured for powering by a remote power source and configured to distribute light longitudinally and radially along the conduit; and
a sealing arrangement at least partially disposed within the electrical input port, wherein:
the elongated illumination source extends from the sealing arrangement;
the sealing arrangement is configured to substantially seal an interface between the electrical input port and the elongated illumination source;
the inlet fitting and the conduit cooperate to define a fluid path that extends from the fluid input port, through the fluid output port, and to a distal end of the conduit; and
the elongated illumination source intersects the fluid path at a location that is downstream from the fluid input port.
